(19) United States
(12) Patent Application Publication
(10) Pub. No.: US 2018/0021981 A1
(43) Pub. Date: Jan. 25, 2018

(54) METHOD FOR RECOVERING SILICON PARTICLES AND ABRASIVE GRAINS FROM WASTED ABRASIVE SLURRY

(71) Applicants: Long-Jin Li, Taichung City (TW); Get Green Energy Corp., Ltd., Taichung City (TW)

(72) Inventors: Po-Nien Lai, Taichung City (TW); Shin-Lee Liu, Taichung City (TW); Huang-Chih Lu, Taichung City (TW)

(73) Assignees: Get Green Energy Corp., Ltd.; Long-Jin Li

(21) Appl. No.: 15/653,388

(22) Filed: Jul. 18, 2017

(30) Foreign Application Priority Data
Jul. 20, 2016 (TW) 105122881

(51) Int. Cl. B28D 5/00; C01B 33/02; B23Q 11/10

(52) U.S. Cl. CPC B28D 5/007; B23Q 11/1069; C01B 33/02; C10N 2240/401

(57) ABSTRACT

Disclosed herein is a method for recovering silicon particles and abrasive grains from a wasted abrasive slurry. The method includes providing a wasted abrasive slurry that contains silicon particles, abrasive grains and a water-soluble glycol, and mixing the wasted abrasive slurry with a metal chloride solution, so as to obtain a micelle layer and a slurry layer, the micelle layer including the water-soluble glycol, and the slurry layer including the silicon particles and the abrasive grains.

### CROSS-REFERENCE TO RELATED APPLICATION

This application claims priority of Taiwanese Patent Application No. 105122881, filed on Jul. 20, 2016.

### FIELD

The disclosure relates to a method for recovering silicon particles and abrasive grains from a wasted abrasive slurry.

### BACKGROUND

Due to the flourishing development of solar energy industry and semiconductor industry, the rapidly growing need for silicon substrates promotes increasing demand for cutting fluid, which is used to slice silicon wafers into silicon substrates.

Cutting fluids, also called abrasive slurries, typically include abrasive grains (such as silicon carbide grains, aluminium oxide grains, zirconium oxide grains, yttrium oxide grains, brown corundum grains, and white corundum grains), lubricants (such as water-soluble glycols) and cooling water.

During the slicing operation, the abrasive grains are rubbed against the silicon wafer surface, causing the cut of silicon wafers and formation of silicon particle in the used abrasive slurries. The water-soluble glycols, such as polyethylene glycol (PEG) and diethylene glycol (DEG), can assist the silicon particle to evenly suspend in the cutting fluids to enhance the slicing accuracy. Also, the water-soluble glycols can not only take away the heat produced during the slicing operation, but can also be easily washed out from the silicon substrates thus formed.

Although the cutting fluids can be repeatedly used, the used abrasive slurries will start producing and accumulating the silicon particles after each repeated uses, resulting in the decrease of the slicing capability and accuracy thereof. To deal with this problem, it is necessary to continuously discharge the wasted abrasive slurries during the slicing operation and resupply with fresh cutting fluids.

Traditionally, the wasted abrasive slurries discharged are directly transferred to a landfill for disposal. The water soluble glycol in the wasted abrasive slurries would cause negative environmental consequences, and the usable abrasive grains and the valuable silicon nanoparticles formed therein may be lost. Currently, a method for recycling abrasive grains (such as silicon carbide), but not for silicon particles, has been developed. The method was conducted by washing the wasted abrasive slurries with sodium hydroxide followed by neutralization with sulfuric acid, in which the oxidation of silicon particles would produce sodium metasilicate (Na₂SiO₃) and silicon dioxide. The silicon carbide precipitates at the bottom for recycling.

### SUMMARY

Therefore, an object of the disclosure is to provide a method for recovering both silicon particles and abrasive grains from a wasted abrasive slurry that can alleviate at least one of the drawbacks of the prior art.

The method includes providing a wasted abrasive slurry that contains silicon particles, abrasive grains and a water-soluble glycol, and mixing the wasted abrasive slurry with a metal chloride solution so as to obtain a micelle layer and a slurry layer. The micelle layer includes the water-soluble glycol, and the slurry layer includes the silicon particles and the abrasive grains.

### DETAILED DESCRIPTION

It is to be understood that, if any prior art publication is referred to herein, such reference does not constitute an admission that the publication forms a part of the common general knowledge in the art, in Taiwan or any other country.

For the purpose of this specification, it will be clearly understood that the word “comprising” means “including but not limited to”, and that the word “comprises” has a corresponding meaning.

Unless otherwise defined, all technical and scientific terms used herein have the meaning commonly understood by a person skilled in the art to which this disclosure belongs. One skilled in the art will recognize many methods and materials similar or equivalent to those described herein, which could be used in the practice of this disclosure. Indeed, this disclosure is in no way limited to the methods and materials described.

According to this disclosure, a method for recovering silicon particles and abrasive grains from a wasted abrasive slurry includes:

providing a wasted abrasive slurry that contains silicon particles, abrasive grains and a water-soluble glycol; and

mixing the wasted abrasive slurry with a metal chloride solution so as to obtain a micelle layer and a slurry layer. The micelle layer is formed above the slurry layer. The micelle layer includes the water-soluble glycol. The slurry layer includes the silicon particles and the abrasive grains.

In certain embodiments, the silicon particles may include silicon microparticles, silicon nanoparticles and the combination thereof.

As used herein, the term “abrasive grains” refer to any grains which can provide slicing, abrading, cutting, polishing, grinding or other material removal properties to a substrate. Examples of the abrasive grains suitable for use in this disclosure include, but are not limited to, silicon carbide grains, aluminium oxide grains, zirconium oxide grains, yttrium oxide grains, brown corundum grains, white corundum grains, or combinations thereof.

According to this disclosure, the water-soluble glycol may be diol, polyol or the combination thereof.

In certain embodiments, the water-soluble glycol may be polyethylene glycol (PEG), diethylene glycol (DEG), ethylene glycol, or combinations thereof.

In certain embodiments, the metal chloride solution may be an alkali metal chloride solution, an alkaline earth metal chloride solution or the combination thereof.

When the water-soluble glycol contacts and reacts with the metal chloride solution, the water-soluble glycol would be aggregated due to the intermolecular attraction, and metal cations of the metal chloride solution would interact with hydroxyl anions of the water-soluble glycol and surround the aggregated water-soluble glycol to form micelles of the micelle layer.

In some embodiments, the metal chloride solution may be alkali metal chloride solution. Examples of the alkali metal chloride solution may include a potassium chloride solution, as odium chloride solution and the combination thereof.

In certain embodiments, the concentration of the alkali metal chloride solution ranges from 1 wt % to saturation. In certain exemplary embodiments, the concentration of the alkali metal chloride solution ranges from 5 wt % to 20 wt %.

In certain embodiments, the weight ratio of the metal chloride solution to the water-soluble glycol in the wasted abrasive slurry is 1:0.5 to 1:3.

In certain embodiments, the step of mixing the wasted abrasive slurry with the metal chloride solution may be performed at a temperature ranging from 25° C. to 70° C.

According to this disclosure, the method may further include subjecting the slurry layer to a separation treatment, so as to obtain an aqueous supernatant and a precipitate that includes the silicon particles and the abrasive grains.

Examples of the separation treatment suitable for the method of this disclosure may include, but are not limited to, centrifugation and filtration. The filtration may be pressure filtration using, e.g., a filter press machine.

According to this disclosure, the method may further include adding an acid solution into the precipitate so as to separate the silicon particles and the abrasive grains. The acid solution may remove the remaining water-soluble glycol on the silicon particles to lower interfacial potential thereof, and may complex with metal ions of the abrasive grains, thereby changing the zeta potentials of the silicon particles and the abrasive grain to facilitate the separation of the silicon particles from the abrasive grains.

In certain embodiments, the acid solution may be an organic acid solution.

In certain exemplary embodiments, the organic acid solution may be carboxylic acid solution. Examples of the carboxylic acid solution suitable for the method of this disclosure may include, but are not limited to, acetic acid solution, citric acid solution, oxalic acid solution, tartaric acid solution, and combinations thereof.

In certain embodiments, the acid solution has a concentration ranging from 1 wt % to 20 wt %.

In certain embodiments, the weight ratio of acid solution to the precipitate may range from 1:1 to 1:20.

The disclosure will be further described by way of the following examples. However, it should be understood that the following examples are solely intended for the purpose of illustration and should not be construed as limiting the disclosure in practice.

### EXAMPLES

In order to determine whether water-soluble glycol in a wasted abrasive slurry would form micelles after reacting with metal chloride, the following test samples are prepared.

### Test Sample 1 (T1)

10 g of silicon particles and 10 g of abrasive grains was added into 40 g of a polyethylene glycol (PEG) solution (5 wt %) under agitation to obtain a abrasive slurry. 40 g of a metal chloride solution including 20 g of a potassium chloride solution (2.5 wt %) and 20 g of a sodium chloride solution (2.5 wt %), was added into and mixed with the abrasive slurry under 25° C. The weight ratio of PEG to metal chloride solution was 1:1. The polyethylene glycol in the abrasive slurry would react with potassium chloride and sodium chloride to form a micelle layer, which was transferred to a graduated test tube to determine the volume (X₀) of the micelle layer.

Afterwards, 5 g of a citric acid solution (10 wt %) was added to the micelle layer, and the volume of the micelle layer was observed and recorded 10 min, 30 min and 60 min after the addition of the citric acid solution (each represented by X₁, X₃ or X₆). A percentage change in the volume of the micelle layer was calculated using the following Equation (I):

A=[(C−B)/C]×100% (I)
A=percentage change in volume (%)
B=the volume of the micelle layer at the designated time after addition of the citric acid solution (X₁, X₃ or X₆)
C=the volume of the micelle layer before addition of the citric acid solution (X₀)

### <Test Samples 2-3 (T2-T3)>

The preparing procedures for T2-T3 are similar to that of T1, except that in T2 and T3, the temperature for mixing the abrasive slurry with the metal chloride solution was respectively 55° C. and 70° C.

### <Test Samples 4-12 (T4-T12)>

The preparing procedures for T4-T6 are respectively similar to those of T1-T3, except that the concentration of the PEG solution is 10 wt % in each of T4-T6.

Both of the preparing procedures for T7-T9 and the preparing procedures for T10-12 are also respectively similar to those of T1-T3, except that the concentration of the PEG solution in each of T7-T9 is 15 wt % and that in each of T10-12 is 20 wt %.

The percentage changes in volume of the micelle layer at different designated time are shown in Table 1.

TABLE 1

| | | | Percentage change in | | |
|---|---|---|---|---|---|
| | | | volume of the micelle | | |
| | PEG solution | Mixing temp. | layer (%) | | |
| Sample | (wt %) | (° C. ) | 10 min | 30 min | 60 min |
| T1 | 5 | 25 | 1 | 6 | 10 |
| T2 | 5 | 55 | 1 | 10 | 15 |
| T3 | 5 | 70 | 1 | 10 | 15 |
| T4 | 10 | 25 | 5 | 25 | 35 |
| T5 | 10 | 55 | 5 | 30 | 40 |
| T6 | 10 | 70 | 5 | 35 | 40 |
| T7 | 15 | 25 | 15 | 30 | 45 |
| T8 | 15 | 55 | 25 | 65 | 70 |
| T9 | 15 | 70 | 35 | 75 | 80 |
| T10 | 20 | 25 | 40 | 50 | 50 |
| T11 | 20 | 55 | 50 | 75 | 80 |
| T12 | 20 | 70 | 55 | 95 | 95 |

It can be seen from Table 1 that under the same mixing temperature, the percentage change in volume of the micelle layer increases with an increase of the concentration of the PEG solution. The result might indicate that the higher the concentration of the PEG solution, the more the micelles formed. In addition, the result also indicated that the higher the temperature when mixing the abrasive slurry with the metal chloride solution, the more the micelles formed.

Method for Recovering Silicon Particles and Abrasive Grains from a Wasted Abrasive Slurry

### Example 1

A ton of a metal chloride solution (which contains 10 wt % sodium chloride and 10 wt % potassium chloride) was added into a ton of a wasted abrasive slurry (which includes 20 wt % of a solution of water-soluble glycol (containing 50 wt % PEG and diethylene glycol), 76 wt % of silicon carbide grains and 4 wt % of silicon micro/nano particles) in a container and then mixed together under agitation. Afterwards, the container was stood still for three hours. The silicon micro/nano particles and the silicon carbide grains precipitated at the bottom of the container as a slurry layer, and the water-soluble glycol are formed into micelles at the top of the container as a micelle layer.

The micelle layer was then taken out from the container, subjected to reduced pressure distillation thereafter to collect the water-soluble glycol. The slurry layer was subjected to a pressure filtration to obtain a filter cake containing the silicon micro/nano particles and the silicon carbide grains. The filter cake was placed in 0.1 ton of 10 wt % citric acid solution for a sufficient time, which resulted in sedimentation of the silicon carbide grains, thereby separating the silicon micro/nano particles from the silicon carbide grains.

### COMPARATIVE EXAMPLE

A wasted abrasive slurry having the same composition as the one in Example 1 was thoroughly mixed with 500 kg of sodium hydroxide and 10 ton of tap water in a container. The mixture was under agitation for 12 hours. A liquid containing water-soluble glycol and sodium metasilicate (Na₂SiO₃), which is produced by the reaction of the silicon micro/nano particles and sodium hydroxide and which could not be recycled in a form of silicon, was formed. The silicon carbide grains were precipitated at the bottom of the container. After being taken out from the container, the liquid was neutralized with a 10 wt % sulfuric acid solution to produce silicon dioxide. The precipitate was also neutralized with 10 wt % sulfuric acid solution, and then washed with 10 ton of tap water twice, so as to obtain the silicon carbide grains.

In view of the foregoing, by virtue of the metal chloride, the wasted abrasive slurry can be easily separated into the micelle layer including the water-soluble glycol, and the slurry layer including the silicon particles and the abrasive grains. In addition, the silicon particles and the abrasive grains in the slurry layer can be further effectively separated and recycled using the acid solution without addition of strong acid (such as sulfuric acid and hydrogen chloride) or strong base (such as metal hydroxides and metal carbonates).

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for recovering silicon particles and abrasive grains from a wasted abrasive slurry, comprising:
providing a wasted abrasive slurry that contains silicon particles, abrasive grains and a water-soluble glycol; and
mixing the wasted abrasive slurry that contains silicon particles, abrasive grains and a water-soluble glycol with a metal chloride solution, so as to obtain a micelle layer and a slurry layer, the micelle layer including the water-soluble glycol, and the slurry layer including the silicon particles and the abrasive grains.

2. The method of claim 1, further comprising subjecting the slurry layer to a separation treatment, so as to obtain an aqueous supernatant and a precipitate that includes the silicon particles and the abrasive grains.

3. The method of claim 2, further comprising adding an acid solution into the precipitate so as to separate the silicon particles and the abrasive grains.

4. The method of claim 3, wherein the acid solution is an organic acid solution.

5. The method of claim 1, wherein the abrasive grains are selected from the group consisting of silicon carbide grains, aluminium oxide grains, zirconium oxide grains, yttrium oxide grains, brown corundum grains, white corundum grains, and combinations thereof.

6. The method of claim 1, wherein the water-soluble glycol is selected from the group consisting of diol, polyol and the combination thereof.

7. The method of claim 6, wherein the water-soluble glycol is selected from the group consisting of polyethylene glycol, diethylene glycol, ethylene glycol, and combinations thereof.

8. The method of claim 1, wherein the metal chloride solution is selected from the group consisting of alkali metal chloride solution, alkaline earth metal chloride solution and the combination thereof.

9. The method of claim 1, wherein the weight ratio of the metal chloride solution to the water-soluble glycol is 1:0.5 to 1:3.

10. The method of claim 1, wherein mixing the wasted abrasive slurry with the metal chloride solution is performed at a temperature ranging from 25° C. to 70° C.
